(19) United States
(12) Patent Application Publication
(10) Pub. No.: US 2025/0219855 A1
(43) Pub. Date: Jul. 3, 2025

(54) UE POLICIES PROVISIONING IN A COMMUNICATIONS NETWORK

(71) Applicant: Telefonaktiebolaget LM Ericsson (publ), Stockholm (SE)

(72) Inventors: Antonio INIESTA GONZALEZ, Madrid (ES); Juying GAN, Shanghai (CN); Maria Belen PANCORBO MARCOS, Madrid (ES); Ralf KELLER, Würselen (DE); Shabnam SULTANA, Montreal (CA); Jan BACKMAN, Kärna (SE)

(21) Appl. No.: 18/851,790

(22) PCT Filed: Mar. 29, 2023
(86) PCT No.: PCT/EP2023/058082

§ 371 Date: Sep. 27, 2024

(30) Foreign Application Priority Data
Mar. 29, 2022 (WO) PCT/CN2022/083847

(51) Int. Cl. H04L 12/14; H04W 60/04; H04W 76/20

(52) U.S. Cl. CPC H04L 12/1407; H04W 60/04; H04W 76/20

(57) ABSTRACT

This disclosure presents a method for provisioning a User Equipment (UE) policy to a UE in the Extended Protocol Configuration Options (ePCO). The method involves provisioning the UE policy to a user terminal via an ePCO, where the UE policy is included in a UE policy container. The UE policy is transmitted from a first network node to the user terminal, where it is received and included in the UE policy container and the ePCO. The method also involves transmitting the UE policy from the first network node to a second network node, where it is included in a UE policy container and the ePCO, before being transmitted to the user terminal.

### TECHNICAL FIELD

The present invention generally relates to provisioning of UE policies in a mobile or communications network and more specifically, the invention relates to the provisioning of UE policies when the UE is attached to EPC.

### BACKGROUND

The UE policy control, as described in 3GPP TS 23.503, enables the PCF to provide UE access selection related policy information, PDU Session related policy information and V2X Policy information to the UE, i.e., UE policies, that includes Access network discovery & selection policy (ANDSP) or UE Route Selection Policy (URSP) or V2X Policy (V2XP) or ProSe Policy (ProSeP) or their combinations using Npcf and Namf service operations.

The PCF may be triggered to provide the UE policy information during UE Policy Association Establishment and UE Policy Association Modification procedures. This procedure is initiated when the PCF wants to update UE policy information (i.e. UE policy) in the UE configuration. The AMF forwards the UE policy information transparently to the UE.

A problematic aspect of current solutions is consistent provision of UE policies (e.g., URSP) to UE across 5GS and EPS.

The UE may use the route selection component (e.g. DNN) in a URSP rule in EPS, but when the URSP rule is updated at network side, there is no way to provision the URSP rule to UE in EPS based on the current design. It is yet to be defined how to support provisioning of URSP to a UE that is consistent across 5GC and EPC. Currently it is not defined how to provision UE policies (e.g., URSP) to UE when served by the EPC and ANDSF is not deployed in the network.

The problem applies to other UE Policies as V2XP, ProseP and ANDSP if no ANDSF is deployed in the network. This limitation is identified as a problem at least in the following scenarios when the UE is in EPS: in relation with Edge Computing, when an AF invokes a request for AF guidance on URSP request applicable to the UE; in other scenarios different than Edge Computing when an AF invokes a request for AF guidance on URSP to dynamically influence in the S-NSSAI/DNN that has to be used for the transfer of traffic for an application in the UE; when a UE is in EPS and there are Operator policies configured in PCF for selecting different URSPs or ANDSPs depending on the time, location or other input condition in PCF; and for V2X and ProSE scenarios where the AF sends a request to change those policies by invoking Service specific parameter provisioning procedure.

### SUMMARY

An object of the invention is to enable the provisioning of UE policies to a User Equipment in EPC.

An aspect of the invention relates to a method performed by a user terminal for provisioning a UE policy from a communications network to a UE in the extended protocol configuration options. The method comprises provisioning to a user terminal a UE policy via an extended protocol configuration option, the user terminal being attached to EPC, the UE policy being included in a UE policy container. In some embodiments, the provisioning of the UE policy comprises: receiving at the user terminal from a first network node the UE policy, wherein the UE policy is included in the UE policy container; and receiving at the user terminal the UE policy, wherein the UE policy is included in the UE policy container and the UE policy container is included in the extended protocol configuration options. In some embodiments, the provisioning of the UE policy comprises: receiving at the user terminal from a second network node the UE policy, wherein the UE policy is included in a UE policy container, and wherein the UE policy container is included in the extended protocol configuration options; In some embodiments, the method further comprises transmitting from the user terminal to the second network node a response to the provisioning of the UE policy, wherein the response is included in a UE policy container, and wherein the response is included in an extended protocol configuration option; In some embodiments, the method further comprises transmitting from the user terminal to the second network node a UE policy container including a UPDP UE STATE INDICATION message with the list of PSIs stored in the UE, wherein the UE policy container is included in a PDN Connectivity request, wherein the UE policy container is included in an extended protocol configuration option; In some embodiments, the UE policy is included or encoded in a UPDP message; In some embodiments, the PCF subscribes to the reception of the response from the UE and subscribes to the reception of the list of PSIs. In some embodiments, the UE policy is transmitted to the user terminal by using the procedure of PDN GW initiated bearer modification without QoS update. In some embodiments, the UE policy is any one of a URSP rule, V2XP, ProseP and ANDSP policies. In some embodiments, the first network node triggers the delivery of UE Policy by selecting a PDU session for the user terminal and triggering a PDU session modification. In some embodiments, the user terminal is a User Equipment (UE), the first network node is a Policy Control Function (PCF) and the second network node is a Session Management Function (SMF) or a Session Management Function+PDN Gateway (SMF+PGW).

An aspect of the invention relates to a method performed by a first network node for provisioning a UE policy from a communications network to a UE in the extended protocol configuration options. The method comprises provisioning from a first network node a UE policy, the UE policy being included in a UE policy container. In some embodiments, the provisioning of the UE policy comprises: transmitting from the first network node to a user terminal the UE policy, wherein the UE policy is included in the UE policy container; In some embodiments, the provisioning of the UE policy comprises: transmitting from the first network node to a second network node the UE policy, wherein the UE policy is included in a UE policy container, and particularly wherein the UE policy container is included in the extended protocol configuration options; In some embodiments, the method further comprises receiving at the first network node from the second network node the UE policy container including the response, wherein the UE policy container is included in an SMF initiated SM Policy Association Modification message, particularly wherein the UE policy container is included in an extended protocol configuration option; In some embodiments, the method further comprises receiving at the first network node from the second network node the UE policy container including the UPDP UE STATE INDICATION message, wherein the UE policy container is included in an SM Policy Association Establishment message, particularly wherein the UE policy container is included in an extended protocol configuration option. In some embodiments, the UE policy is included or encoded in a UPDP message. In some embodiments, the PCF subscribes to the reception of the response from the UE and subscribes to the reception of the list of PSIs. In some embodiments, the UE policy container is transmitted from the first network node to the second network node in an SM Policy Association Modification message. In some embodiments, the UE policy is transmitted to the user terminal by using the procedure of PDN GW initiated bearer modification without QoS update. In some embodiments, the UE policy is any one of a URSP rule, V2XP, ProseP and ANDSP policies. In some embodiments, the first network node triggers the delivery of UE Policy by selecting a PDU session for the user terminal and triggering a PDU session modification. In some embodiments, the user terminal is a User Equipment (UE), the first network node is a Policy Control Function (PCF) and the second network node is a Session Management Function (SMF) or a Session Management Function+PDN Gateway (SMF+PGW).

An aspect of the invention relates to a method performed by a second network node for provisioning a UE policy from a communications network to a UE in the extended protocol configuration options. The method comprises provisioning to a user terminal a UE policy via an extended protocol configuration option, the user terminal being attached to EPC, the UE policy being included in a UE policy container; In some embodiments, the provisioning of the UE policy comprises: receiving at a second network node from a first network node the UE policy, wherein the UE policy is included in a UE policy container, and particularly wherein the UE policy container is included in the extended protocol configuration options; and transmitting from the second network node to the user terminal the UE policy, wherein the UE policy is included in a UE policy container, and wherein the UE policy container is included in the extended protocol configuration options. In some embodiments, the method further comprises receiving at the second network node from the user terminal a response to the provisioning of the UE policy, wherein the response is included in a UE policy container, and wherein the response is included in an extended protocol configuration option; and transmitting from the second network node to the first network node the UE policy container including the response, wherein the UE policy container is included in an SMF initiated SM Policy Association Modification message, particularly wherein the UE policy container is included in an extended protocol configuration option. In some embodiments, the method further comprises receiving at the second network node from the user terminal a UE policy container including a UPDP UE STATE INDICATION message with the list of PSIs stored in the UE, wherein the UE policy container is included in a PDN Connectivity request, wherein the UE policy container is included in an extended protocol configuration option; and transmitting from the second network node to the first network node the UE policy container including the UPDP UE STATE INDICATION message, wherein the UE policy container is included in an SM Policy Association Establishment message, particularly wherein the UE policy container is included in an extended protocol configuration option. In some embodiments, the UE policy is included or encoded in a UPDP message. In some embodiments, the PCF subscribes to the reception of the response from the UE and subscribes to the reception of the list of PSIs. In some embodiments, the UE policy container is transmitted from the first network node to the second network node in an SM Policy Association Modification message. In some embodiments, the UE policy is transmitted to the user terminal by using the procedure of PDN GW initiated bearer modification without QoS update. In some embodiments, the UE policy is any one of a URSP rule, V2XP, ProseP and ANDSP policies. In some embodiments, the first network node triggers the delivery of UE Policy by selecting a PDU session for the user terminal and triggering a PDU session modification. In some embodiments, the user terminal is a User Equipment (UE), the first network node is a Policy Control Function (PCF) and the second network node is a Session Management Function (SMF) or a Session Management Function+PDN Gateway (SMF+PGW). Other aspects of the invention relate to mobile network nodes, particularly a user terminal (101, 700), a second network node (107, 900), a first network node (111, 800) configured to perform the respective methods as described herein. Other aspects of the invention relate to computer program and computer program products.

In some embodiments, the user terminal is a User Equipment (UE). In some embodiments, the second network node is a Session Management Function (SMF). In some embodiments, the first network node is a Policy Control Function (PCF).

Advantageously, the solution disclosed herein enables the network to provision or update UE Policies to a UE when the UE is attached in EPC, further enabling the support of Edge Computing functionality in EPC, etc.

Additional objectives, features and advantages of the concepts disclosed herein will be apparent from the following description, claims and drawings, or may be learned by practice of the described technologies and concepts as set forth herein.

Generally, all terms used in the claims are to be interpreted according to their ordinary meaning in the technical field, unless explicitly defined otherwise herein. All references to ““a/an/the element, apparatus, component, means, module, step, etc.”” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.”

### BRIEF DESCRIPTION OF THE DRAWINGS

In order to best describe the manner in which the disclosed concepts may be implemented, as well as define other objects, advantages and features of the disclosure, a more particular description is provided below and is illustrated in the appended drawings. Understanding that these drawings depict only exemplary embodiments of the invention and are not therefore to be considered to be limiting in scope, the examples will be described and explained with additional specificity and detail through the use of the accompanying drawings in which:

FIG. 1 illustrates an example networked system in accordance with particular embodiments of the solution described herein;

FIG. 2 illustrates an example signaling diagram showing a procedure according to particular embodiments of the solution described herein;

FIG. 3 illustrates an example signaling diagram showing a procedure according to particular embodiments of the solution described herein;

FIG. 4 illustrates an example flowchart showing a method performed by a UE according to particular embodiments of the solution described herein;

FIG. 5 illustrates an example flowchart showing a method performed by a mobile network node according to particular embodiments of the solution described herein;

FIG. 6 illustrates an example flowchart showing a method performed by a mobile network node according to particular embodiments of the solution described herein;

FIG. 7 illustrates an example block diagram of a UE configured in accordance with particular embodiments of the solution described herein.

FIG. 8 illustrates an example block diagram of a mobile network node configured in accordance with particular embodiments of the solution described herein.

FIG. 9 illustrates an example block diagram of a mobile network node configured in accordance with particular embodiments of the solution described herein.

FIG. 10 illustrates an example signaling diagram showing a procedure according to particular embodiments of the solution described herein.

FIG. 11 illustrates an example signaling diagram showing a procedure according to particular embodiments of the solution described herein.

FIG. 12 illustrates an example signaling diagram showing a procedure according to particular embodiments of the solution described herein.

### DETAILED DESCRIPTION

The invention will now be described in detail hereinafter with reference to the accompanying drawings, in which examples of embodiments or implementations of the invention are shown. The invention may, however, be embodied or implemented in many different forms and should not be construed as limited to the embodiments set forth herein. Rather, these embodiments are provided so that this disclosure will be thorough and complete, and will fully convey the scope of present invention to those skilled in the art. It should also be noted that these embodiments are not mutually exclusive. Components from one embodiment may be tacitly assumed to be present/used in another embodiment. These embodiments of the disclosed subject matter are presented as teaching examples and are not to be construed as limiting the scope of the disclosed subject matter. For example, certain details of the described embodiments may be modified, omitted, or expanded upon without departing from the scope of the described subject matter.

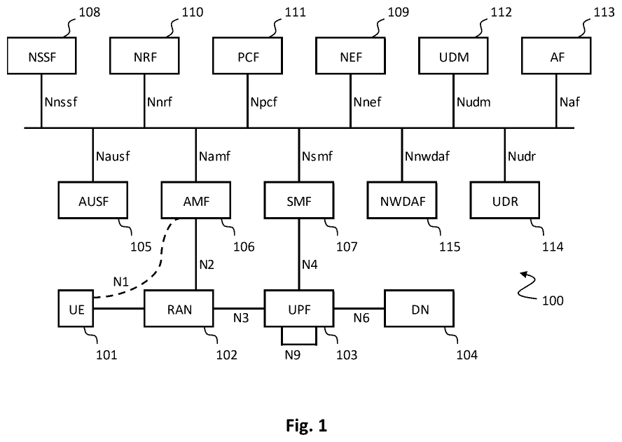

The example embodiments described herein arise in the context of a telecommunications network, including but not limited to a telecommunications network that conforms to and/or otherwise incorporates aspects of a fifth generation (5G) architecture. FIG. 1 is an example networked system 100 in accordance with example embodiments of the present disclosure. FIG. 1 specifically illustrates User Equipment (UE) 101, which may be in communication with a (Radio) Access Network (RAN) 102 and Access and Mobility Management Function (AMF) 106 and User Plane Function (UPF) 103. The AMF 106 may, in turn, be in communication with core network services including Session Management Function (SMF) 107 and Policy Control Function (PCF) 111. The core network services may also be in communication with an Application Server/Application Function (AS/AF) 113. Other networked services also include Network Slice Selection Function (NSSF) 108, Authentication Server Function (AUSF) 105, User Data Management (UDM) 112, Network Exposure Function (NEF) 109, Network Repository Function (NRF) 110 and Data Network (DN) 104. In some example implementations of embodiments of the present disclosure, an AMF 106, SMF 107, UPF 103, PCF 111, AUSF 105, NRF 110, UDM 112, NEF 109, AF 113, and NSSF 108 are each considered to be an NF. One or more additional instances of the network functions (NF) may be incorporated into the networked system.

The solution described herein aims to enable the provisioning of UE policies to a User Equipment in EPC.

The solution in this invention proposes a mechanism that allows the network to update the UE Policies for a UE in EPC, by encapsulating UPDP messages related to a UE Policy update into a new ePCO parameter (from now on UE Policy Container ePCO) and transfer them to the UE via a PDN connection.

The mechanism reuses the existing capability of the EPC network for sending ePCO from the UE to the SMF+PGW-C(and vice versa) and in addition it proposes a way to transport the UE Policy Container from the SMF+PGW-C to the PCF (and vice versa) based on reusing existing PDU session procedures.

When the PCF needs to send a UE Policy update towards the UE in EPC, it invokes a SM Policy Association Modification including the corresponding UPDP message into a new IE in the N7 interface. When the SMF+PGW-C receives this new IE the SMF+PGW-C encapsulates it into UE Policy Container ePCO and transfers them to the UE by using existing procedure of PDN GW initiated bearer modification without bearer QoS update.

When the UE in EPC needs to send a UPDP message towards the PCF in relation to UE Poliy handling the UE first encapsulates the UPDP message into a UE Policy Container ePCO and then transfers it towards the SMF+PGW-C by reusing existing mechanisms. When the SMF+PGW-C receives such UE Policy Container ePCO from the UE, just forwards transparently the UE Policy Container towards the PCF by reusing SMF initiated SM Policy Association procedure.

The solution also proposes that the UE has to be able to handle the reception of such UPDP messages received over EPC NAS signalling in a similar way than when received over 5GC NAS signalling in 5GC.

Last, the PCF also has to be able to handle the reception of UPDP messages from the UE over PDN connection related procedures in a similar way than when received from the AMF in 5GC.

The solution applies for the delivery of any UE Policy.

The PCF refers to a deployment where the PCF serving the UE and the PCF serving each of the PDU Sessions of this UE are the same PCF.

In summary, the solution comprises:
UE sends/receives UE policy container in ePCO via EPC.
SMF+PGW-C decapsulate UE policy container from ePCO received from UE and send it to PCF and encapsulate UE policy container received from PCF into ePCO.
PCF receives UE policy container from SMF+PGW-C(when UE is in EPC), and PCF sends UE policy container to SMF+PGW-C(when UE is in EPC).

The PCF triggers the delivery of UE Policy updates for a UE in EPC by selecting on of the ongoing PDU sessions for the UE and triggering a PCF initiated PDU session modification on it.

The solution in this invention proposes a mechanism that allows the network to update the UE Policies for a UE in EPC, by encapsulating UPDP messages into a new ePCO parameter (from now on UE Policy Container ePCO) and transfer them to the UE via PDN connection.

The mechanism reuses the existing capability of the EPC network for sending ePCO from the UE to the SMF+PGW-C(and vice versa) and in addition it proposes a way to transport the UE Policy Container from the SMF+PGW-C to the PCF (and vice versa).

For the delivery of UE Policies to UEs in EPC, this solution assumes the standard solution for interworking architecture between EPC and 5GC as described in 3GPP TS 23.501.

From the PCF side it is proposed that the PCF needs to mimic the handling and processing of UPDP messages which is done in 5GC when those messages are received over N15, to the case of EPC when those are received over PDU session procedures. Then the PCF will support the reception and handling of a UE Policy container including UPDP message UE STATE INDICATION as part of PDU session establishment procedure and will be able to generate and send MANAGE UE POLICY COMMAND UPDP message to the UE triggering a PCF initiated PDU session modification procedure. Also the PCF will support the reception and handling of a UE Policy Container including UPDP message MANAGE UE POLICY COMPLETE or MANAGE UE POLICY COMMAND REJECT as part of SMF initiated PDU Session modification.

For the SMF+PGW-C, it is proposed that when the SMF+PGW-C receives a UE Policy Container in a new IE within a PCF initiated SM Policy modification, it encapsulates into a UE Policy Container ePCO and sends it to the UE by triggering a bearer modification procedure without bearer QoS update (as defined in 23.401 section 5.4.3). Then when the SMF+PGW-C receives the answer from the UE, if it contains a UE Policy Container ePCO then the SMF+PGW-C provides the UE Policy Container ePCO to PCF by triggering a SMF initiated SM Policy modification. In addition, if the SMF+PGW-C receives a UE Policy Container ePCO as part of a procedure for requesting PDN connectivity, the SMF+PGW-C provides the content of the UE Policy Container to the PCF.

This solution also proposes that the UE will mimic the handling and processing of UPDP messages which is done in 5GC, to the case of EPC when those are received in UE Policy Container ePCO over Session Management procedures. Then it is proposed the UE generates and sends UPDP UE STATE INDICATION via UE Policy Container ePCO when it attaches to EPC. Also, the UE needs to support the reception and handling of UPDP UE POLICY COMMAND as part of Session Management Request procedure and support sending MANAGE UE POLICY COMPLETE or MANAGE UE POLICY COMMAND REJECT in the corresponding Session Management Response.

For those cases where the UE attaches to EPC but doesn't request the establishment of a default bearer there won't be any PDU session created for the UE as part of the attach procedure, there is no need for the UE to include UE STATE INDICATION as part of the attach procedure. However, for those cases, the UE needs to include UE STATE INDICATION within a UE Policy Container ePCO during the first UE request for PDN connectivity. Then the PCF will be able to update the UE Policies to the UE only after the establishment of the first PDU session establishment for the UE.

In addition, for those events happening in PCF which may trigger the sending of a UE Policy update for a UE (e.g. the one triggered by an AF guidance on URSP request), the PCF will check if the UE is currently in EPC, and if so will use one of these PDU sessions to trigger the delivery of the UE Policy updates, by invoking PCF initiated SM Policy modification procedure including the proper UE Policy Container.

It is assumed a deployment where all the PDU sessions for a UE are handled by the same PCF.

This disclosure provides a method for provisioning a UE policy from a communications network to a UE in the extended protocol configuration options. The method comprises provisioning to a user terminal a UE policy via an extended protocol configuration option, the user terminal being attached to EPC, the UE policy being included in a UE policy container. In some embodiments, the provisioning of the UE policy comprises: transmitting from a first network node to the user terminal the UE policy, wherein the UE policy is included in the UE policy container; and receiving at the user terminal the UE policy, wherein the UE policy is included in the UE policy container and the UE policy container is included in the extended protocol configuration options. In some embodiments, the provisioning of the UE policy comprises: transmitting from the first network node to a second network node the UE policy, wherein the UE policy is included in a UE policy container, and particularly wherein the UE policy container is included in the extended protocol configuration options; and transmitting from the second network node to the user terminal the UE policy, wherein the UE policy is included in a UE policy container, and wherein the UE policy container is included in the extended protocol configuration options. In some embodiments, the method further comprises transmitting from the user terminal to the second network node a response to the provisioning of the UE policy, wherein the response is included in a UE policy container, and wherein the response is included in an extended protocol configuration option; and transmitting from the second network node to the first network node the UE policy container including the response, wherein the UE policy container is included in an SMF initiated SM Policy Association Modification message, particularly wherein the UE policy container is included in an extended protocol configuration option. In some embodiments, the method further comprises transmitting from the user terminal to the second network node a UE policy container including a UPDP UE STATE INDICATION message with the list of PSIs stored in the UE, wherein the UE policy container is included in a PDN Connectivity request, wherein the UE policy container is included in an extended protocol configuration option; and transmitting from the second network node to the first network node the UE policy container including the UPDP UE STATE INDICATION message, wherein the UE policy container is included in an SM Policy Association Establishment message, particularly wherein the UE policy container is included in an extended protocol configuration option. In some embodiments, the UE policy is included or encoded in a UPDP message. In some embodiments, the PCF subscribes to the reception of the response from the UE and subscribes to the reception of the list of PSIs. In some embodiments, the UE policy container is transmitted from the first network node to the second network node in an SM Policy Association Modification message. In some embodiments, the UE policy is transmitted to the user terminal by using the procedure of PDN GW initiated bearer modification without QoS update. In some embodiments, the UE policy is any one of a URSP rule, V2XP, ProseP and ANDSP policies. In some embodiments, the first network node triggers the delivery of UE Policy by selecting a PDU session for the user terminal and triggering a PDU session modification. In some embodiments, the user terminal is a User Equipment (UE), the first network node is a Policy Control Function (PCF) and the second network node is a Session Management Function (SMF) or a Session Management Function+PDN Gateway (SMF+PGW).

This disclosure also provides mobile network nodes, particularly a user terminal (101, 700), a second network node (107, 900), a first network node (111, 800) configured to perform the respective methods as described herein. In some embodiments, the user terminal is a User Equipment (UE) 101. In some embodiments, the second network node is a Session Management Function (SMF) 107. In some embodiments, the first network node is a Policy Control Function (PCF) 111.

This disclosure also provides the corresponding computer program and computer program products comprising code, for example in the form of a computer program, that when run on processing circuitry of the mobile network nodes causes the mobile network nodes to perform the disclosed methods.

Advantageously, the solution disclosed herein enables the network to provision or update UE Policies to a UE when the UE is attached in EPC, further enabling the support of Edge Computing functionality in EPC, etc.

Hereinafter, drawings showing examples of embodiments of the solution are described in detail.

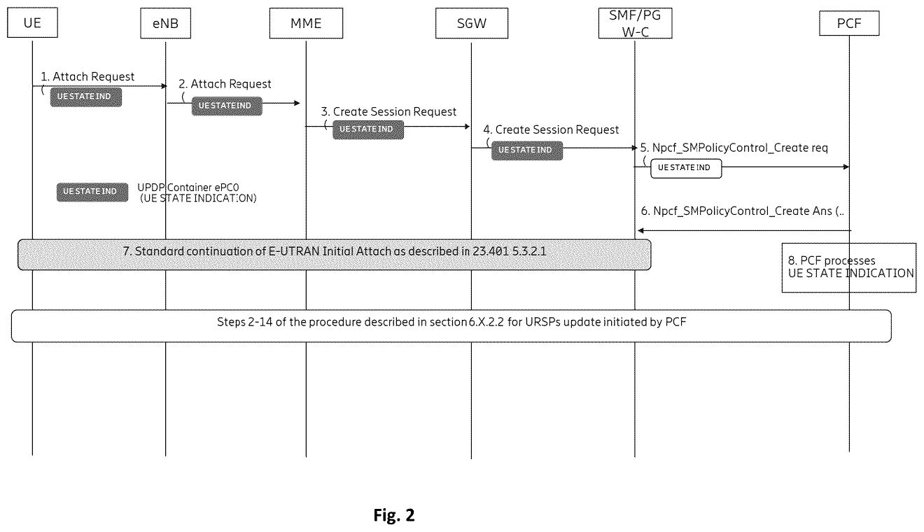

FIG. 2 is a signaling diagram illustrating a procedure for provisioning a UE policy as an extended protocol configuration option in a communications network. This sequence diagram is an example of the procedure to update the UE policies in a UE during the Initial Attachment in EPC. The example is based on URSPs.

For the initial attachment of a UE in EPC, the procedure follows the one defined in TS 23.401 section 5.3.2.1 with the following additions summarized in the figure below:

Step 1: The UE generates UE STATE INDICATION UPDP message (including the list of PSIs stored in the UE) in the same way that it is done for the registration in 5GC. Then the UE includes this UE STATE INDICATION UPDP message into UE Policy Container ePCO in PDN Connectivity Request encapsulated in Attach Request.

Steps 2-4: These steps follow the existing procedure as defined in 23.401, so the UE Policy Container ePCO is sent towards the SMF+PGW-C

Note: In this flow it is considered the case where UE initial attachment procedure also includes the establishment of the default PDN connection.

Step 5: the SMF+PGW-C forwards transparently the content of the UE Policy Container ePCO to the PCF as a new IE in Npcf_SMPolicyControl_Create Request.

Note: Upon the reception of this UE Policy Container ePCO, the SMF+PGW-C shall establish the corresponding SM Policy Association even in case the network configuration for the APN of the PDN connection does not require PCF involvement.

Steps 6: The PCF answers to the SMF with Npcf_SMPolicyControl_Create Response Step 7: The procedure for initial attachment continues as defined in 23.401 section 5.3.2.1.

Step 8: The PCF gets the content of the UE STATE INDICATION included in new IE and processes it in a similar way than it does when it is received in 5GC during the UE Policy Association establishment, i.e. uses the list of UPSIs included in the UE STATE INDICATION to determine if an update of UE policies is required for this UE. If no update is determined the procedure finishes here. If an update is needed, then the PCF generates the corresponding UPDP message MANAGE UE POLICY COMMAND in a similar way than it is done in 5GC and then includes the message into a new IE for sending it to the SMF over N7.

Note: The interactions toward UDR in relation with the retrieving and storage of UPSIs into UDR are not shown in the diagram.

The flow follows the steps 2-14 defined in section 6.X.2.2 for URSP update initiated by PCF.

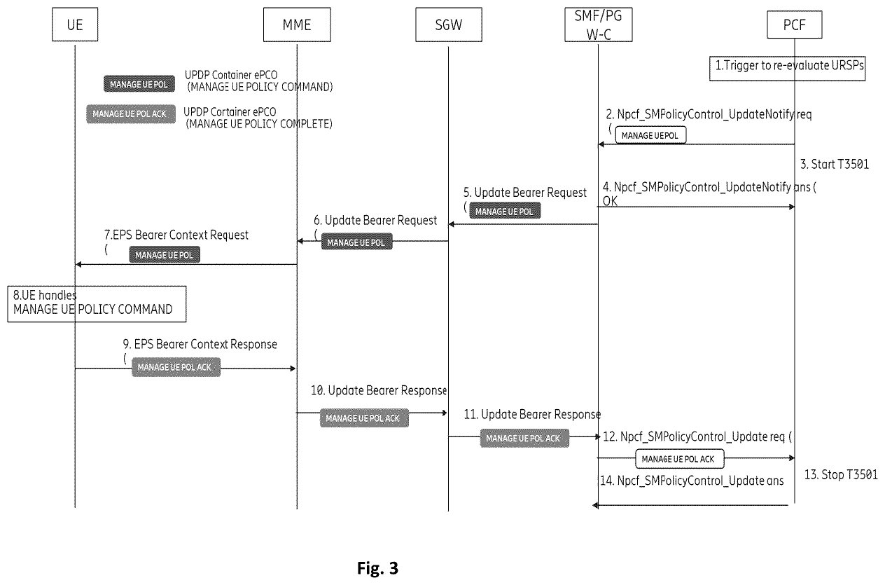

FIG. 3 is a signaling diagram illustrating a procedure for provisioning a UE policy as an extended protocol configuration option in a communications network. This sequence diagram is an example of the procedure to update the UE policies in a UE during the Initial Attachment in EPC. The example is based on URSPs. For the procedure for URSP update initiated by the PCF when the UE is in EPC, the procedure follows the steps described in the figure below:

Step 1: An event as described in section 6.X.1.1 happens in PCF. The PCF triggers the (re-) evaluation of applicable URSPs for the UE and determines an update of URSP is needed for the UE. The PCF selects one of the PDN connection/PDU sessions associated to EPC for the delivery of the URSP update. Then the PCF generates the corresponding UPDP message MANAGE UE POLICY COMMAND in a similar way than it is done in 5GC and then includes the message into a new IE for sending it to the SMF over N7.

Step 2: The UPDP message is then provided to the SMF+PGW-C by invoking Npcf_SMPolicyControl_UpdateNotify request.

Step 3: The PCF starts timer T3501 to monitor the reception of an answer for UPDP MANAGE UE POLICY COMMAND.

Step 4: The SMF+PGW-C, upon reception of new IE with UPDP message, answers the PCF with Npcf_SMPolicyControl_UpdateNotify response and initiates a bearer modification procedure without bearer QoS update (as defined in 23.401 section 5.4.3) to provide the UE Policy Container ePCO towards the UE.

Steps 5-7: These steps follow the existing procedure for bearer modification procedure without bearer QoS

Step 8: When the UE in EPC gets the UE Policy Container ePCO including a MANAGE UE POLICY COMMAND UPDP message, the UE processes that message in a similar way than when it is received in 5GC, i.e. stores the URSP updates, optionally re-evaluates the mapping of applications into PDN connections according to the mapping of URSP values into EPC, and generates UPDP message MANAGE UE POLICY COMMAND COMPLETE with the result to the PCF.

Step 9: The UE then generates a UE Policy Container including the MANAGE UE POLICY COMMAND COMPLETE, and include it in the EPS Bearer Context Response sent to the MME.

Step 10-11: These steps follow the existing procedure defined for Update Bearer Response

Step 12: Upon reception of UE Policy Container ePCO in Update Bearer Response, the SMF+PGW-C then invokes Npcf_SMPolicyControl_Update Request including the content of the UE Policy Container.

Step 13: The PCF processes the MANAGE UE POLICY COMMAND COMPLETE in a similar way than in 5GC as defined in TS 29.525 and stops timer T3501.

Step 14: The PCF sends Npcf_SMPolicyControl_Update Response.

Hereinafter, flowcharts showing examples of embodiments of the solution are described in detail. The embodiments correspond to methods performed by and involving a user terminal (101, 700), a second network node (107, 900), a first network node (111, 800).

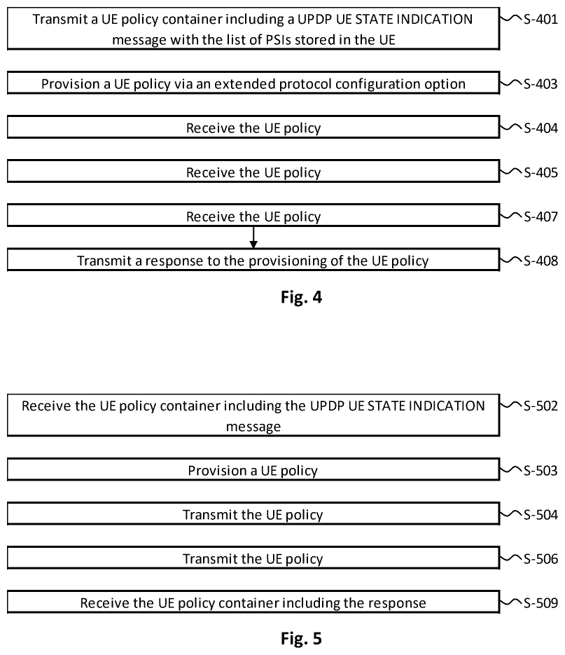

FIG. 4 is a flowchart illustrating a method performed by the user terminal for provisioning a UE policy from a communications network to a UE in the extended protocol configuration options.

In step S-401, the user terminal transmits to the second network node a UE policy container including a UPDP UE STATE INDICATION message with the list of PSIs stored in the UE, wherein the UE policy container is included in a PDN Connectivity request, wherein the UE policy container is included in an extended protocol configuration option.

In some embodiments, the provisioning of the UE policy comprises:

In step S-403, the user terminal provisions a UE policy via an extended protocol configuration option, the user terminal being attached to EPC, the UE policy being included in a UE policy container.

In step S-404, the user terminal receives from a first network node the UE policy, wherein the UE policy is included in the UE policy container.

In some embodiments, the provisioning of the UE policy comprises:

In step S-405, the user terminal receives the UE policy, wherein the UE policy is included in the UE policy container and the UE policy container is included in the extended protocol configuration options.

In step S-407, the user terminal receives from a second network node the UE policy, wherein the UE policy is included in a UE policy container, and wherein the UE policy container is included in the extended protocol configuration options.

In step S-408, the user terminal transmits to the second network node a response to the provisioning of the UE policy, wherein the response is included in a UE policy container, and wherein the response is included in an extended protocol configuration option.

In some embodiments, the UE policy is included or encoded in a UPDP message.

In some embodiments, the PCF subscribes to the reception of the response from the UE and subscribes to the reception of the list of PSIs.

In some embodiments, the UE policy is transmitted to the user terminal by using the procedure of PDN GW initiated bearer modification without QoS update.

In some embodiments, the UE policy is any one of a URSP rule, V2XP, ProseP and ANDSP policies.

In some embodiments, the first network node triggers the delivery of UE Policy by selecting a PDU session for the user terminal and triggering a PDU session modification.

In some embodiments, the user terminal is a User Equipment (UE), the first network node is a Policy Control Function (PCF) and the second network node is a Session Management Function (SMF) or a

Session Management Function+PDN Gateway (SMF+PGW).

FIG. 5 is a flowchart illustrating a method performed by the first network node for provisioning a UE policy from a communications network to a UE in the extended protocol configuration options.

In step S-502, the first network node receives from the second network node the UE policy container including the UPDP UE STATE INDICATION message, wherein the UE policy container is included in an

SM Policy Association Establishment message, particularly wherein the UE policy container is included in an extended protocol configuration option.

In some embodiments, the provisioning of the UE policy comprises:

In step S-503, the first network node provisions a UE policy, the UE policy being included in a UE policy container.

In some embodiments, the provisioning of the UE policy comprises:

In step S-504, the first network node transmits to a user terminal the UE policy, wherein the UE policy is included in the UE policy container.

In step S-506, the first network node transmits to a second network node the UE policy, wherein the UE policy is included in a UE policy container, and particularly wherein the UE policy container is included in the extended protocol configuration options.

In step S-509, the first network node receives from the second network node the UE policy container including the response, wherein the UE policy container is included in an SMF initiated SM Policy Association Modification message, particularly wherein the UE policy container is included in an extended protocol configuration option.

In some embodiments, the UE policy is included or encoded in a UPDP message.

In some embodiments, the PCF subscribes to the reception of the response from the UE and subscribes to the reception of the list of PSIs.

In some embodiments, the UE policy container is transmitted from the first network node to the second network node in an SM Policy Association Modification message.

In some embodiments, the UE policy is transmitted to the user terminal by using the procedure of PDN GW initiated bearer modification without QoS update.

In some embodiments, the UE policy is any one of a URSP rule, V2XP, ProseP and ANDSP policies.

In some embodiments, the first network node triggers the delivery of UE Policy by selecting a PDU session for the user terminal and triggering a PDU session modification.

In some embodiments, the user terminal is a User Equipment (UE), the first network node is a Policy Control Function (PCF) and the second network node is a Session Management Function (SMF) or a Session Management Function+PDN Gateway (SMF+PGW).

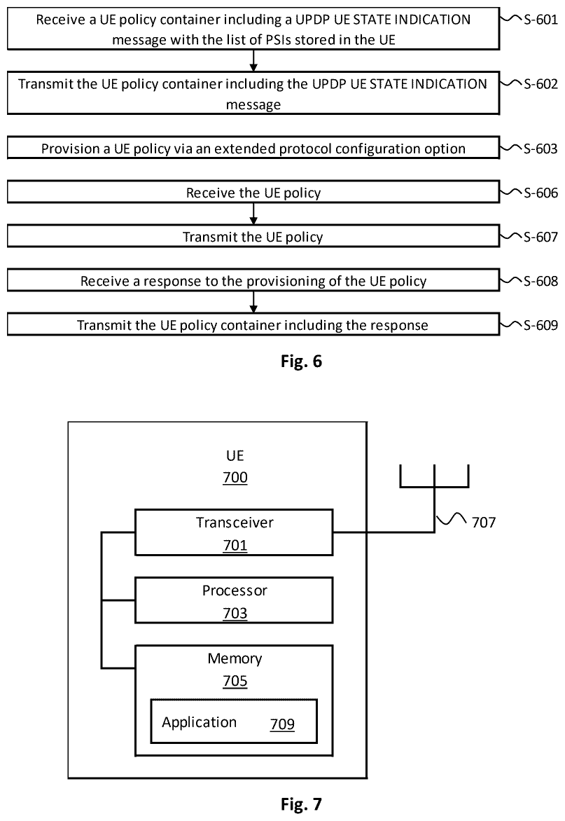

FIG. 6 is a flowchart illustrating a method performed by the second network node for provisioning a UE policy from a communications network to a UE in the extended protocol configuration options.

In step S-601, the second network node receives from the user terminal a UE policy container including a UPDP UE STATE INDICATION message with the list of PSIs stored in the UE, wherein the UE policy container is included in a PDN Connectivity request, wherein the UE policy container is included in an extended protocol configuration option.

In some embodiments, the provisioning of the UE policy comprises:

In step S-602, the second network node transmits to the first network node the UE policy container including the UPDP UE STATE INDICATION message, wherein the UE policy container is included in an SM Policy Association Establishment message, particularly wherein the UE policy container is included in an extended protocol configuration option.

In step S-603, the user terminal provisions a UE policy via an extended protocol configuration option, the user terminal being attached to EPC, the UE policy being included in a UE policy container.

In step S-606, the second network node receives from a first network node the UE policy, wherein the UE policy is included in a UE policy container, and particularly wherein the UE policy container is included in the extended protocol configuration options.

In step S-607, the second network node transmits to the user terminal the UE policy, wherein the UE policy is included in a UE policy container, and wherein the UE policy container is included in the extended protocol configuration options.

In step S-608, the second network node receives from the user terminal a response to the provisioning of the UE policy, wherein the response is included in a UE policy container, and wherein the response is included in an extended protocol configuration option.

In step S-609, the second network node transmits to the first network node the UE policy container including the response, wherein the UE policy container is included in an SMF initiated SM Policy Association Modification message, particularly wherein the UE policy container is included in an extended protocol configuration option.

In some embodiments, the UE policy is included or encoded in a UPDP message.

In some embodiments, the PCF subscribes to the reception of the response from the UE and subscribes to the reception of the list of PSIs.

In some embodiments, the UE policy container is transmitted from the first network node to the second network node in an SM Policy Association Modification message.

In some embodiments, the UE policy is transmitted to the user terminal by using the procedure of PDN GW initiated bearer modification without QoS update.

In some embodiments, the UE policy is any one of a URSP rule, V2XP, ProseP and ANDSP policies.

In some embodiments, the first network node triggers the delivery of UE Policy by selecting a PDU session for the user terminal and triggering a PDU session modification.

In some embodiments, the user terminal is a User Equipment (UE), the first network node is a Policy Control Function (PCF) and the second network node is a Session Management Function (SMF) or a Session Management Function+PDN Gateway (SMF+PGW).

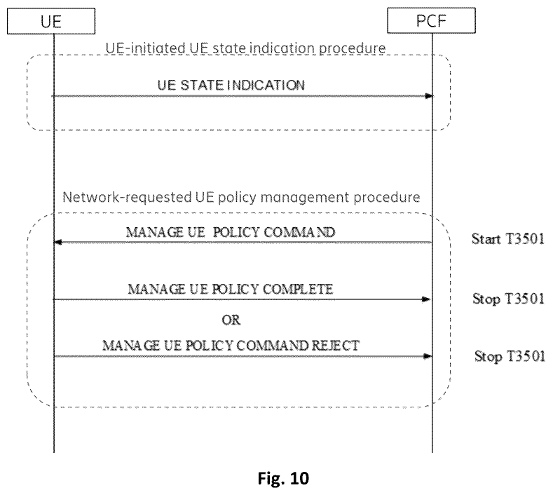

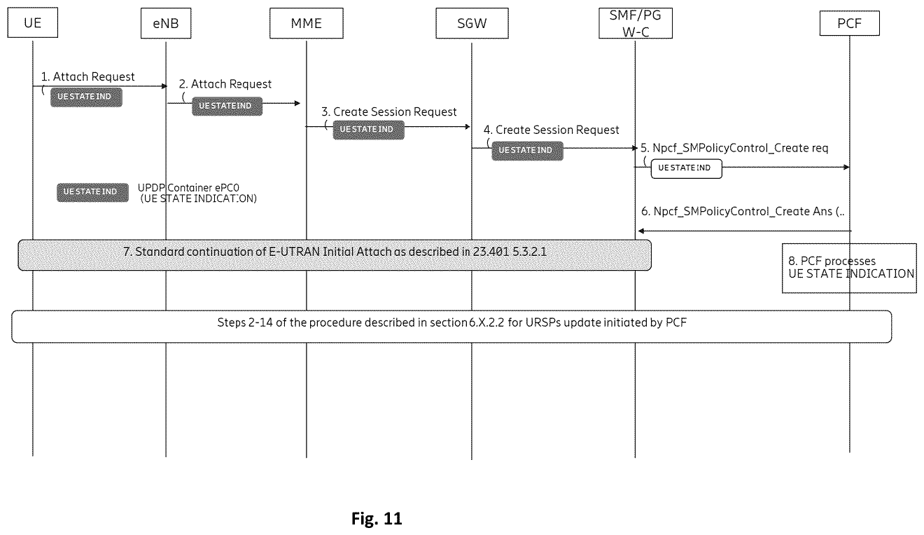

In general, and in relation to FIG. 10, the Policy Control Function (PCF) in certain scenarios may need to update the User Repository Subscription Profiles (URSPs) in User Equipment (UE) in both the 5G Core (5GC) and the Evolved Packet Core (EPC) networks. One such scenario occurs during the initial attach procedure in the EPC network, when the UE is first registering with the network. For example, if an Application Function (AF) sends new guidance on URSP requests that are applicable to the UE while it is deregistered and before the EPC attach procedure, the corresponding URSP rules may not have been delivered yet to the UE. Similarly, if operator policies for determining URSPs are updated while the UE is deregistered and before the EPC attach procedure, the corresponding URSP rules may not have been delivered to the UE.

URSP updates may also be required while the UE is registered in the EPC network, which could be due to a new AF guidance on URSP requests being sent by the AF or due to changes in the network conditions. For instance, if an operator policy configured for URSP determination is applicable in new network conditions, the PCF may determine that new or updated URSP rules need to be applied to the UE.

In any of these scenarios, the PCF sends a MANAGE UE POLICY COMMAND to the UE, which contains the updated policies. The UE responds with either a MANAGE UE POLICY COMPLETE or a MANAGE UE POLICY COMMAND REJECT message to indicate whether the update was successful. By updating URSPs in the UE, the PCF can ensure that the UE has the latest policies and can continue to operate effectively within the network.

In 5GC, the distribution of updates to User Equipment (UE) policies is critical to ensuring that the network operates effectively and efficiently. To facilitate this process, a procedure for the distribution of policies to UE has been defined in TS 23.503 section 6.1.2.2.2. This procedure involves delivering updates from the Policy Control Function (PCF) to the UEs.

To distribute the UE policies, a protocol has been defined between the UE and the PCF, known as the UE Policy Delivery Protocol (UPDP). This protocol is summarized in FIG. 10 and described in detail in 3GPP TS 24.501. The UPDP messages are encapsulated into N1 Policy Containers, which are then transferred transparently between the Access and Mobility Management Function (AMF) and the UEs.

When a UE receives an update to its policies, it needs to inform the PCF about the Policy Sections stored in the UE. This is accomplished using the UE STATE INDICATION operation, which provides the PCF with a list of stored Policy Section Identifiers (PSIs). The PCF can then use this information to manage the distribution of policies to the UE.

To update the UE policies, the PCF employs the Network-requested UE Policy management procedure. This procedure involves sending a MANAGE UE POLICY COMMAND to the UE, which contains the updated policies. The UE responds with either a MANAGE UE POLICY COMPLETE or a MANAGE UE POLICY COMMAND REJECT message to indicate whether the update was successful. By following this procedure, the PCF can ensure that all UEs have the latest policies and that the network operates effectively.

This disclosure proposes a mechanism for updating User Repository Subscription Profiles (URSPs) in User Equipment (UE) in the Evolved Packet Core (EPC) network. The proposed mechanism involves encapsulating UE Policy Delivery Protocol (UPDP) messages into a new parameter called UE Policy Container ePCO and transferring them to the UE via Packet Data Network (PDN) connections. This mechanism assumes the same protocol (UPDP protocol) for URSP delivery between the Policy Control Function (PCF) and the UE as in the 5G Core (5GC).

The proposed solution reuses the existing capability of the EPC network for sending ePCO between the UE and the Serving Gateway (SMF+PGW-C), and it proposes a way to transport the UE Policy Container from the SMF+PGW-C to the PCF (and vice versa) based on reusing existing PDU session procedures. To deliver URSPs to UEs in EPC, this solution assumes the standard solution for interworking architecture between EPC and 5GC as described in 3GPP TS 23.501.

When the PCF needs to send a UE Policy update towards the UE in EPC, it invokes a SM Policy Association Modification including the corresponding UPDP message into a new IE (UE Policy Container) in the N7 interface. The SMF+PGW-C then encapsulates it into UE Policy Container ePCO and transfers it to the UE using an existing procedure of PDN GW initiated bearer modification without bearer QoS update. Similarly, when the UE in EPC needs to send a UPDP message towards the PCF in relation to UE Policy handling, it encapsulates the UPDP message into a UE Policy Container ePCO and transfers it towards the SMF+PGW-C by reusing existing mechanisms.

The solution proposes that the UE should be able to handle the reception of such UPDP messages received over EPC NAS signalling in a similar way as when received over 5GC NAS signalling. For events happening in the PCF that may trigger the sending of a URSP update for a UE, the PCF will check if the UE is currently in EPC and, if so, will use one of these PDU sessions to trigger the delivery of the URSP updates by invoking a PCF-initiated SM Policy Association modification procedure, including the proper UE Policy Container. Finally, the PCF deployment in this solution refers to a deployment where the PCF serving the UE and the PCF serving each of the PDU sessions of this UE are the same PCF.

FIG. 11 depicts a procedure for the initial attachment of a UE in EPC, the procedure follows the one defined in TS 23.401 section 5.3.2.1 with the steps described below for the support of URSP deliveries to the UE:

Step 1: The UE generates UE STATE INDICATION UPDP message (including the list of PSIs stored in the UE) in the same way that it is done for the registration in 5GC. Then the UE includes this UE STATE INDICATION UPDP message into UE Policy Container ePCO in PDN Connectivity Request encapsulated in Attach Request

For those cases where the UE attaches to EPC but doesn't request the establishment of a default bearer the procedure just follows the steps defined in TS 23.401 section 5.3.2.1 and there is no PCF interaction. However, for those cases, the UE will include UE STATE INDICATION within a UE Policy Container ePCO during the first request for PDN connectivity. Then the PCF will be able to update the URSPs to the UE only after the establishment of the first PDU session establishment for the UE.

Steps 2-4: These steps follow the existing procedure as defined in TS 23.401, so the UE Policy Container ePCO is sent towards the SMF+PGW-C.

Step 5: the SMF+PGW-C forwards transparently the UE Policy Container ePCO to the PCF as a new IE in the PDU Session Establishment (Npcf_SMPolicyControl_Create Request).

Upon the reception of this UE Policy Container ePCO, the SMF+PGW-C shall establish the corresponding SM Policy Association even in case the network configuration for the APN of the PDN connection does not require PCF involvement.

Step 6: The PCF answers to the SMF with Npcf_SMPolicyControl_Create Response.

Step 7: The procedure for initial attach continues as defined in 23.401 section 5.3.2.1.

Step 8: the PCF gets the content of the UE STATE INDICATION included in new IE and processes it in a similar way than it does when it is received in 5GC during the UE Policy Association establishment, i.e. uses the list of UPSIs included in the UE STATE INDICATION to determine if an update of UE policies is required for this UE. If no update is determined the procedure finishes here. If an update is needed, then the PCF generates the corresponding UPDP message MANAGE UE POLICY COMMAND in a similar way than it is done in 5GC and then includes the message into a UPDP Container ePCO.

The interactions toward UDR in relation with the retrieving and storage of UPSIs into UDR are not shown in the diagram.

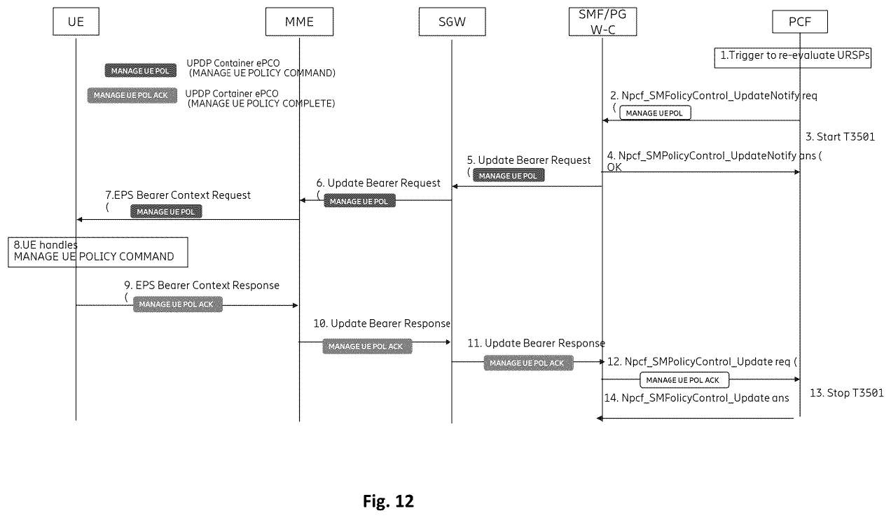

Then, the flow follows the steps 2-14 defined in FIG. 12 for URSP update initiated by PCF.

FIG. 12 depicts a procedure for URSP update initiated by the PCF when the UE is in EPC, the procedure follows the following steps:

Step 1: An event takes place in PCF. The PCF triggers the re-evaluation of applicable URSPs for the UE and determines an update of URSP is needed for the UE. The PCF selects one of the PDN connection/PDU sessions associated to EPC for the delivery of the URSP update. Then the PCF generates the corresponding UPDP message MANAGE UE POLICY COMMAND in a similar way than it is done in 5GC and then includes the message into a new IE for sending it to the SMF over N7.

Step 2: The UPDP message is then provided to the SMF+PGW-C by invoking Npcf_SMPolicyControl_UpdateNotify request.

Step 3: The PCF starts timer T3501 to monitor the reception of an answer for UPDP MANAGE UE

POLICY COMMAND.

Step 4: The SMF+PGW-C, upon reception of the new IE with UPDP message, answers the PCF with Npcf_SMPolicyControl_UpdateNotify response and initiates a bearer modification procedure without bearer QoS update (as defined in 23.401 section 5.4.3) to provide the UE Policy Container ePCO towards the UE.

Steps 5-7: These steps follow the existing procedure for bearer modification procedure without bearer Qos

Step 8: When the UE gets the UE Policy Container ePCO including a MANAGE UE POLICY COMMAND UPDP message, the UE processes that message in a similar way than when it is received in 5GC, i.e. stores the URSP updates, optionally re-evaluates the mapping of applications into PDN connections according to the mapping of URSP values into EPC, and generates UPDP message MANAGE UE POLICY COMMAND COMPLETE with the result to the PCF.

Step 9: The UE then generates a UE Policy Container UPDP including the MANAGE UE POLICY COMMAND COMPLETE, and include it in the EPS Bearer Context Response sent to the MME.

Step 10-11: These steps follow the existing procedure defined for Update Bearer Response Step 12: Upon reception of UE Policy Container ePCO in Update Bearer Response, the SMF+PGW-C then invokes Npcf_SMPolicyControl_Update Request including the content of the UE Policy Container ePCO.

Step 13: The PCF processes the MANAGE UE POLICY COMMAND COMPLETE in a similar way than in 5GC as defined in TS 29.525 and stops timer T3501.

Step 14: The PCF sends Npcf_SMPolicyControl_Update Response.

FIG. 7 is a block diagram illustrating elements of a User Equipment (UE) 700 (also referred to as a communication device, a mobile terminal, a mobile communication terminal, a wireless device, a wireless communication device, a wireless terminal, mobile device, a wireless communication terminal, a user equipment node/terminal/device, etc.) configured to provide wireless communication according to embodiments of the disclosure. As shown, communication device UE may include an antenna 707, and transceiver circuitry 701 (also referred to as a transceiver) including a transmitter and a receiver configured to provide uplink and downlink radio communications with a base station(s) (also referred to as a RAN node) of a radio access network. The UE may also include processing circuitry 703 (also referred to as a processor) coupled to the transceiver circuitry, and memory circuitry 705 (also referred to as memory, e.g. corresponding to device readable medium) coupled to the processing circuitry. The memory circuitry 705 may include computer readable program code, such as application client 709, that when executed by the processing circuitry 703 causes the processing circuitry to perform operations according to embodiments disclosed herein. According to other embodiments, processing circuitry 703 may be defined to include memory so that separate memory circuitry is not required. The UE 700 may also include an interface (such as a user interface) coupled with processing circuitry 703, and/or the UE may be incorporated in a vehicle. As discussed herein, operations of the UE may be performed by processing circuitry 703 and/or transceiver circuitry 701. For example, processing circuitry 703 may control transceiver circuitry 701 to transmit communications through transceiver circuitry 701 over a radio interface to a radio access network node (also referred to as a base station) and/or to receive communications through transceiver circuitry 701 from a RAN node over a radio interface. Moreover, modules may be stored in memory circuitry 705, and these modules may provide instructions so that when instructions of a module are executed by processing circuitry 703, processing circuitry 703 performs respective operations (e.g., the operations disclosed herein with respect to the example embodiments relating to the UE).

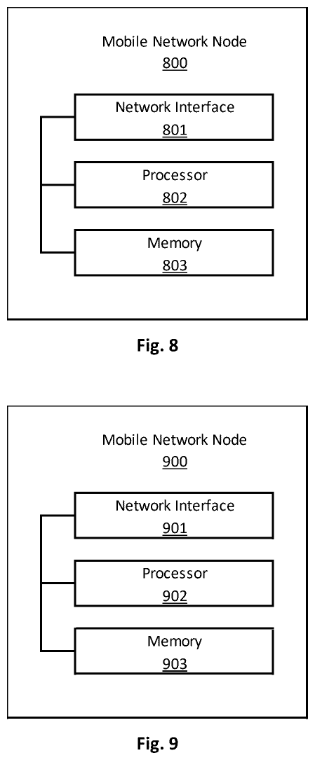

FIG. 8 is a block diagram illustrating elements of a mobile network node 800 of a mobile communications network. In some embodiments, the mobile network node 800 is a PCF 111. As shown, the mobile network node may include network interface circuitry 801 (also referred to as a network interface) configured to provide communications with other nodes of the core network and/or the network. The mobile network node may also include a processing circuitry 802 (also referred to as a processor) coupled to the network interface circuitry, and memory circuitry 803 (also referred to as memory) coupled to the processing circuitry. The memory circuitry 803 may include computer readable program code that when executed by the processing circuitry 802 causes the processing circuitry to perform operations according to embodiments disclosed herein. According to other embodiments, processing circuitry 802 may be defined to include memory so that a separate memory circuitry is not required. As discussed herein, operations of the mobile network node may be performed by processing circuitry 802 and/or network interface circuitry 801. For example, processing circuitry 802 may control network interface circuitry 801 to transmit communications through network interface circuitry 801 to one or more other network nodes and/or to receive communications through network interface circuitry from one or more other network nodes. Moreover, modules may be stored in memory 803, and these modules may provide instructions so that when instructions of a module are executed by processing circuitry 802, processing circuitry 802 performs respective operations (e.g., operations discussed below with respect to Example Embodiments relating to core network nodes).

FIG. 9 is a block diagram illustrating elements of a mobile network node 900 of a mobile communications network. In some embodiments, the mobile network node 900 is an SMF 107. As shown, the mobile network node may include network interface circuitry 901 (also referred to as a network interface) configured to provide communications with other nodes of the core network and/or the network. The mobile network node may also include a processing circuitry 902 (also referred to as a processor) coupled to the network interface circuitry, and memory circuitry 903 (also referred to as memory) coupled to the processing circuitry. The memory circuitry 903 may include computer readable program code that when executed by the processing circuitry 902 causes the processing circuitry to perform operations according to embodiments disclosed herein. According to other embodiments, processing circuitry 902 may be defined to include memory so that a separate memory circuitry is not required. As discussed herein, operations of the mobile network node may be performed by processing circuitry 902 and/or network interface circuitry 901. For example, processing circuitry 902 may control network interface circuitry 901 to transmit communications through network interface circuitry 901 to one or more other network nodes and/or to receive communications through network interface circuitry from one or more other network nodes. Moreover, modules may be stored in memory 903, and these modules may provide instructions so that when instructions of a module are executed by processing circuitry 902, processing circuitry 902 performs respective operations (e.g., operations discussed below with respect to Example Embodiments relating to core network nodes).

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such tangible computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the tangible computer-readable media.

Computer-executable instructions include, for example, instructions and data which cause a general purpose computer, special purpose computer, or special purpose processing device to perform a certain function or group of functions. Computer-executable instructions also include program modules that are executed by computers in standalone or network environments. Generally, program modules include routines, programs, objects, components, and data structures that perform particular tasks or implement particular abstract data types. Computer executable instructions, associated data structures, and program modules represent examples of the program code means for executing steps of the methods disclosed herein. The particular sequence of such executable instructions or associated data structures represent examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Communication at various stages of the described system can be performed through a local area network, a token ring network, the Internet, a corporate intranet, 802.11 series wireless signals, fiber-optic network, radio or microwave transmission, etc. Although the underlying communication technology may change, the fundamental principles described herein are still applicable.

The various embodiments described above are provided by way of illustration only and should not be construed to limit the invention. For example, the principles herein may be applied to any remotely controlled device. Further, those of skill in the art will recognize that communication between the remote the remotely controlled device need not be limited to communication over a local area network but can include communication over infrared channels, Bluetooth or any other suitable communication interface. Those skilled in the art will readily recognize various modifications and changes that may be made to the present invention without following the example embodiments and applications illustrated and described herein, and without departing from the scope of the present disclosure.

### Abbreviations

ePCO Extended Protocol Configuration Option
UPDP UE Policy Delivery Protocol
URSP UE Routing and Selection Policy

1.-53. (canceled)

54. A method performed by a User Equipment, UE, for provisioning a UE policy in a communications network, the method comprising:
receiving a UE policy from a network node via extended protocol configuration options, ePCO, wherein the UE is attached to Evolved Packet Core, EPC, and wherein the UE policy is included in a UE policy container.

55. The method of claim 54, further comprising:
transmitting to the network node a response to the received the UE policy via ePCO, wherein the response is included in a UE policy container.

56. The method of claim 54, further comprising:
transmitting to the network node a UE policy container including a UPDP UE STATE INDICATION message with the list of Policy Section Identifiers, PSIs, stored in the UE, wherein the UE policy container is included in a PDN Connectivity request, wherein the UE policy container is transmitted via ePCO.

57. The method of claim 54, wherein the UE policy is included or encoded in a UE Policy Delivery Protocol, UPDP, message.

58. The method of claim 54, wherein the UE policy is received at the UE by using the procedure of PDN Gateway initiated bearer modification without Quality of Service, QoS, update.

59. The method of claim 54, wherein the UE policy is any one of a User Route Selection Policy, URSP, Vehicle-to-Everything Policy, V2XP, Proximity Services Policy, ProseP, and Access Network Discovery and Selection Policy, ANDSP.

60. The method of claim 54, wherein the network node is a Policy Control Function, PCF, a Session Management Function, SMF, or a Session Management Function+PDN Gateway, SMF+PGW.

61. A method performed by a first network node for provisioning a User Equipment, UE, policy in a communications network, the method comprising:
transmitting to a UE or a second network node the UE policy via extended protocol configuration options, ePCO, wherein the UE policy is included in a UE policy container.

62. The method of claim 61, further comprising:
receiving from the UE or the second network node via ePCO a UE policy container including a response to the provisioning of the UE policy.

63. The method of claim 61, wherein the UE policy container is included in a Session Management, SM, Policy Association Modification message.

64. The method of claim 61, wherein the UE policy container received at the first network node includes a UPDP UE STATE INDICATION message with the list of Policy Section Identifiers, PSIs, stored in the UE.

65. The method of claim 61, wherein the UE policy container is included in a Session Management, SM, Policy Association Establishment message.

66. The method of claim 61, wherein the UE policy is included or encoded in a UE Policy Delivery Protocol, UPDP, message.

67. The method of claim 61, wherein the UE policy is transmitted to the UE by using the procedure of PDN Gateway initiated bearer modification without Quality of Service, QoS, update.

68. The method of claim 61, wherein the UE policy is any one of a User Route Selection Policy, URSP, Vehicle-to-Everything Policy, V2XP, Proximity Services Policy, ProseP, and Access Network Discovery and Selection Policy, ANDSP.

69. The method of claim 61, wherein the first network node or the second network node is a Policy Control Function, PCF, a Session Management Function, SMF, or a Session Management Function+PDN Gateway, SMF+PGW.

70. A apparatus for provisioning a User Equipment, UE, policy in a communications network, the apparatus comprising:
a processor;
a memory, the memory containing instructions executable by the processor such that the apparatus is operable to perform operation comprising:
receive a UE policy from a network node via extended protocol configuration options, ePCO, wherein the UE is attached to Evolved Packet Core, EPC, and wherein the UE policy is included in a UE policy container.

71. A apparatus for provisioning a User Equipment, UE policy in a communications network, the apparatus comprising:
a processor;
a memory, the memory containing instructions executable by the processor such that the apparatus is operable to perform operations comprising:
transmit to a UE or a second network node the UE policy via extended protocol configuration options, ePCO, wherein the UE policy is included in a UE policy container.
